(19) United States
(12) Patent Application Publication
(10) Pub. No.: US 2007/0217772 A1
(43) Pub. Date: Sep. 20, 2007

(54) INTEGRATED LIGHT HEAD APPARATUS AND METHODS OF USE THEREOF

(76) Inventor: Greg M. Lemelson, Southborough, MA (US)

Correspondence Address: ANTOINETTE G. GIUGLIANO, P.C., 100 Cummings Center, Suite 342G, Beverly, MA, 01915, US

(21) Appl. No.: 11/564,108

(22) Filed: Nov. 28, 2006

(51) Int. Cl. G03B 15/02

(52) U.S. Cl. 396/4

(57) ABSTRACT

The present invention relates to a light head having a parabolic head and at least one connector for attaching a photographic accessory such as a softbox. The light head further includes a power source. The present invention includes light heads with a plurality of connectors (e.g., between about 1 and about 12 connectors). The power source is adapted to receive the parabolic head. The connector rotates clockwise, counterclockwise, or both, with respect to the power source. The present invention includes methods for using light head, and kits and systems including the light head.

### BACKGROUND OF THE INVENTION

A speed ring allows for the attachment of light modifiers, such as a softbox, to a light source. When a photographer wants to attach a parabolic head (e.g., a head with a reflective surface that allows for increased light scatter), the photographer generally has to disconnect the parabolic head in order to connect the speed ring, and visa versa.

As such, a need exists to have a device that allows for the simultaneous use of a parabolic head and connectors for the attachment of a photographic accessory like a softbox. A further need exists to allow the connectors to rotate in order to allow the user to place the accessory in the desired position. Yet a further need exists to easily attach such accessories.

### SUMMARY OF THE INVENTION

The present invention includes an integrated light head that has a parabolic head; at least one connector (e.g., between about 1 and about 12 connectors, and preferably between about 6 and about 8 connectors) at the parabolic head; and a power source for electrically powering the parabolic head. The power source is adapted to receive the parabolic head. The connector rotates clockwise, counterclockwise, or both, with respect to the power source. The parabolic head includes a base having at least the connector, shaped to receive the parabolic head, and, in an embodiment, the power source can be threaded to receive the parabolic head. The light head further comprises an attachment for slidably attaching the base with the power source. The device further includes a light socket, coupled with the power source. The parabolic head preferably has a reflective surface (e.g., has reflective properties including a type of reflective material and/or textured surface).

In an embodiment, the light head includes a parabolic head; at least about two connectors at the parabolic head; and a power source for electrically powering the parabolic head, wherein the power source is adapted to receive the parabolic head, wherein the connector rotates clockwise, counterclockwise, or both, with respect to the power source. The connectors include at least one connector shaped to receive a softbox frame member.

In an embodiment, the connector placed at the parabolic head has a keyhole and is shaped to receive a member of a photographic accessory (e.g., a light modifier such as a softbox). In particular, the keyhole includes a front face, wherein the front face is adapted to receive a frame member of a softbox member, and at least one side face, wherein the side face is adapted to secure the frame member. The opening that receives and secures the frame member, in one aspect, is continuous, and has a “U” shape.

The present invention relates to light systems and kits. The systems or kits encompass the light head of the present invention and a photographic accessory.

The present invention includes methods for providing lighting with the light head of the present invention. The methods include attaching a photograph accessory to one or more connectors, and providing electricity to the power source.

The present invention provides several advantages. The integrated light head of the present invention allows a user (e.g., a photographer) to use a parabolic head while at the same time having the ability to connect a photographic accessory such a softbox. The user no longer has to choose between one or the other, but can use both at the same time and on the same light source. The present invention further allows the user to rotate the connectors to place the softbox in the desired position without having to disconnect, reposition the light head. In addition, the present invention advantageously provides a keyhole to allow the user to more easily attach a frame member of a softbox.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view showing the front of the integrated light head having 6 connectors.

FIG. 1A is a detailed view of a connector of the integrated light head, wherein the connector acts as a keyhole.

FIG. 2 is another perspective view showing the back of the integrated light of the present invention.

FIG. 3 is a perspective view showing the front of the integrated light head having 8 connectors.

FIG. 4 is a perspective view showing an octagonal softbox attached to the light head of the present invention.

FIG. 5 is a perspective view showing a standard, rectangular softbox attached to the light head of the present invention.

### DETAILED DESCRIPTION OF THE INVENTION

A description of preferred embodiments of the invention follows.

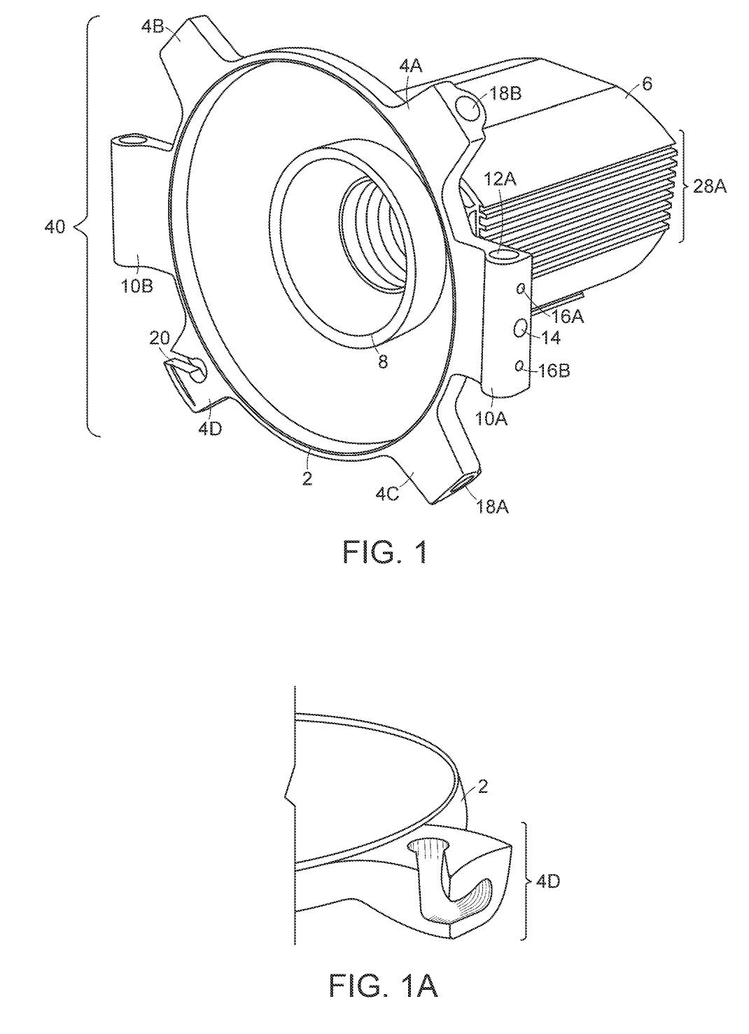

Referring to FIG. 1, the present invention involves an integrated light head connector. In particular, light head 40 has parabolic head 2 with integrated softbox connectors 4A,4B,4C and 4D used for connecting a standard, rectangular softbox, and connectors 10A and 10B, used for connecting a strip softbox. Parabolic head 2 is partially formed from a concave or bowl-like shape base, and has an opening for receiving bulb socket 8 of power source 6. The parabolic head, in an embodiment, is lined with a reflective material that allows for the light to be scattered in different directions. The present invention can use reflective material currently used for parabolic heads, or reflective material developed in the future. Examples of such reflective material include aluminum, glass (e.g., micros glass balls), silver (e.g., silver steel), nickel, and plastic compositions or alloys. Parabolic heads can range in size and curvature, to achieve the desired light effect.

Softbox connectors 4A-D are integrated and placed on the outside edge or circumference parabolic head 2. Such connectors can be integrated and placed anywhere on the parabolic so long as the connectors can be used for the attachment of a softbox. Connectors 4A-C are protrusions having a recess, on the side face of the protrusion, for receiving ends of a softbox frame member. Many softbox frames are members that have some flexibility to allow a user to set up the softbox, but are taught enough to hold the proper shape. Such frame members are similar to those used in tents. The shape of a connector preferably complements the frame member used to secure the photographic accessory.

Connector 4D is shaped differently than connectors 4A-C, and acts as a key hole for the softbox frame member. As shown in FIG. 1A, connector 4D has an opening on the front face as well as on the side face, an opening which is continuous. This opening forms, in part, a shape similar to a “U” shape. Connector 4D is shaped to assist the user in installing in the last frame member of a softbox. After inserting the three frame members into the recess in the side face of connectors 4A-C, the user can simply insert the last frame member into front face of connector 4D, and then slide the member into position (e.g., into the recess of the side face). Without a continuous opening from the front face to the side face, the user often has more of a struggle to secure the last frame member. While having a connector with an opening like that of connector 4D is encompassed in one embodiment of the present invention, other embodiments include an integrated light head having a fourth connector shaped like connector 4A-C.

FIG. 1 shows openings 18A and 18B as being essentially parallel to the front face of the connector. In an embodiment, openings of the connectors and/or the connectors themselves, can be angled to better accommodate the frame members. Instead of the connectors being essentially flush with the edge of the parabolic head, the connectors and/or the openings can be angled forward (e.g., between about 10 degrees and about 45 degrees).

Light head 40 also has two more connectors, connectors 10A and 10B, used for connecting a strip softbox. The present invention encompasses light heads having connectors that attach more than one type of softbox (e.g., about 2, 3, or 4 types of softboxes). Connectors 10A and 10B are used to mount the frame members of the long sides of the strip softbox. Connectors 10A and 10B have cylindrical recess 12A that receives the frame member of the strip softbox. Once the frame member is inserted into the opening, the softbox can be secured with a screw or clip that is inserted into openings 14 and/or 16A-B. Any device can be used to secure the photographic accessory to any of the connectors, and include, e.g., screws, clips, fasteners, snaps, ties, and rods. Any such device now known or developed in the future can be used to secure an accessory to the connector.

The integrated connectors can be of any shape or size, or angled or positioned, to accommodate the photographic accessory to be mounted or secured. The shape of the integrated connectors, in an embodiment, complements the frame or support of the accessory to be attached to the light head. Connectors can be shaped to allow connection of more than one photographic accessory, or to allow accessories to be otherwise clipped or mounted. Also, any number of connectors can be integrated with the parabolic head, e.g., between about 1 and about 12 connectors can be present, and preferably between about 4 and about 8.

The integrated light head of the present invention can be used to attach any number of photographic accessories, including for example, softboxes. Several types of softboxes can be attached to the light of the present invention, and include standard rectangular softboxes, strip softboxes, octagonal softboxes, hexagon softboxes, lantern softboxes, and pancake softboxes. Connectors can be modified to complement the support members or frames of these softboxes. The present invention can be modified to accommodate softboxes now known or later developed.

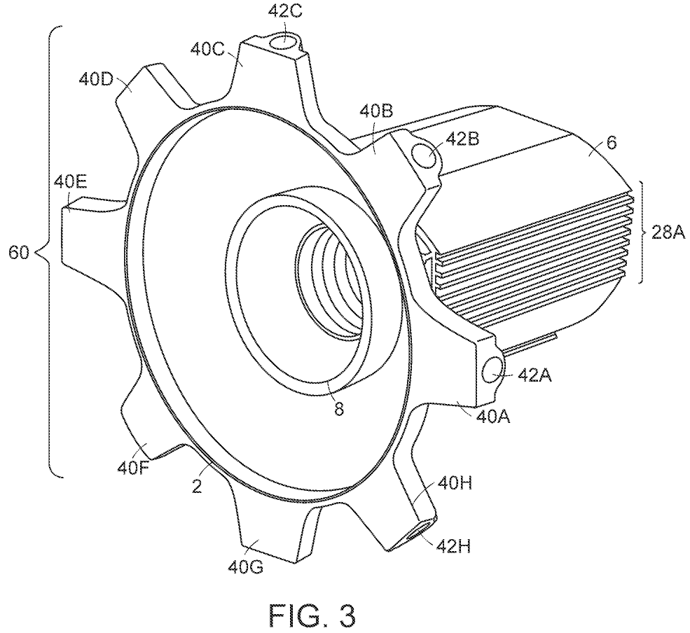

FIG. 3 shows light head 60 with 8 connectors, softbox connectors 40A-H. The 8 connector light head shown in FIG. 3 can be used, in one aspect, to connect an octagonal softbox. FIG. 4 shows octagonal softbox 80 connected to light head 60 on light stand 84. Octagonal softbox 80 has eight frame members 82A-H (some not shown), which are inserted into recess 40A-G of light head 60.

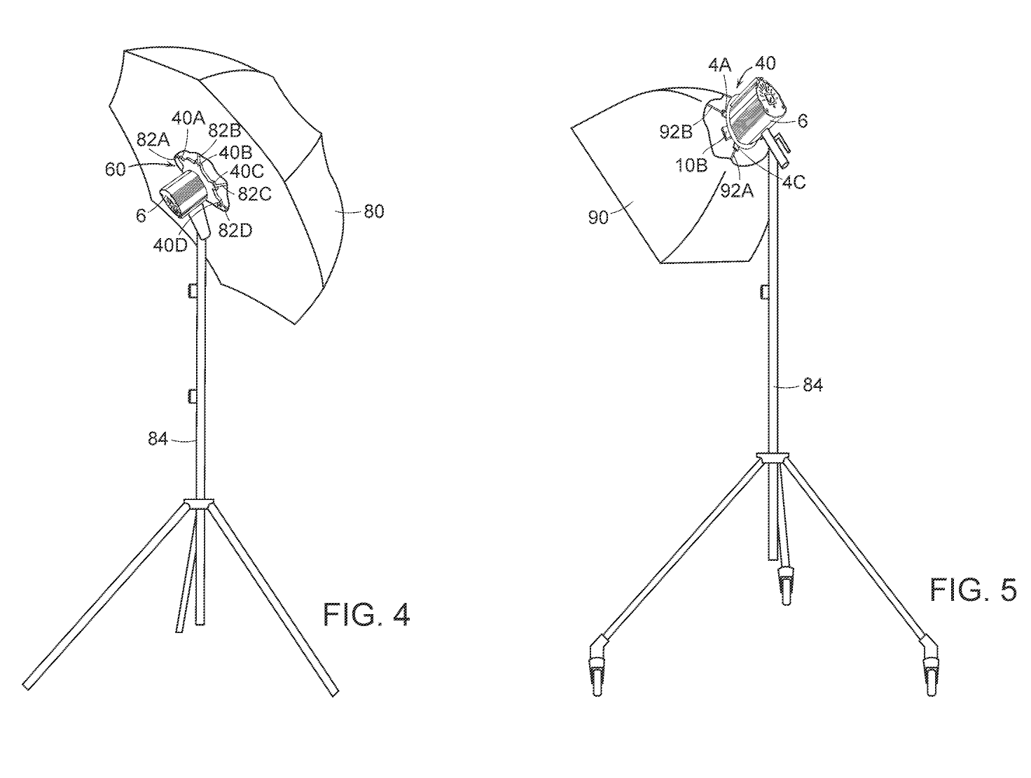

FIG. 5 shows a standard, rectangular softbox, softbox 90, attached to light head 40 on light stand 84. Frame members 92A and 92B are inserted into the recesses (e.g., recess 18A and 18B) of connectors 4A-D. The rectangular softbox has 4 frame members that are connector to the light head. Although not shown, frame members of a strip softbox would be inserted into connectors 10A and B of light head 40.

The integrated light head can be made of any material so long as the material is strong enough to support the accessory to be mounted. Preferably, the material can also withstand the heat from the light bulb used. Examples of such materials include cast metal (e.g., cast aluminum), plastic, machined metal, injection molded, composite material, carbon fiber, CNC, or protruded aluminum. Any material now known or developed in the future can be used so long as it can be shaped into a connector that supports one or more photograph accessories and withstand the heat from the power source.

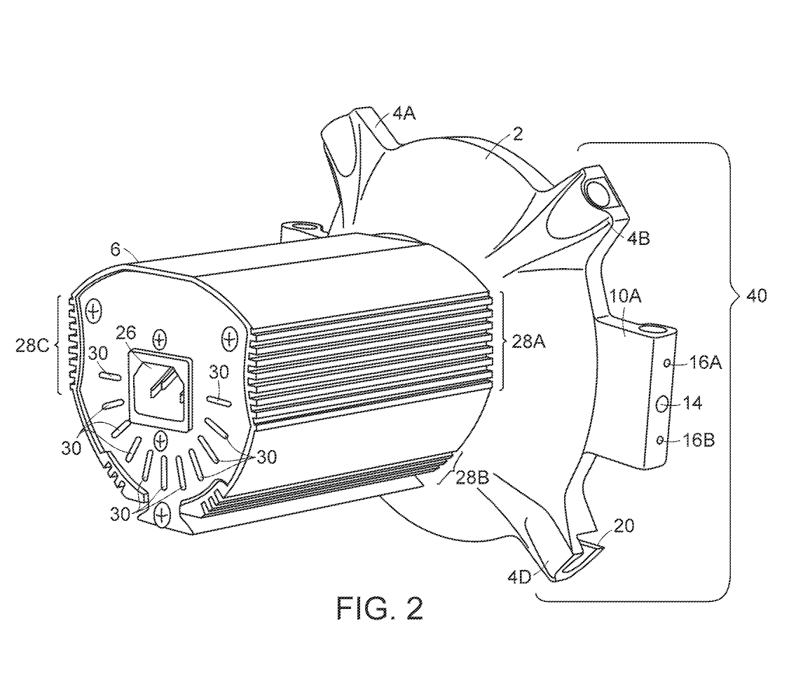

Connectors rotate with respect to the power source 6. The connectors slidably connect to the power source, or otherwise rotate in a clockwise or counterclockwise fashion to allow the user to position the connectors in a desired position. Rotating the connectors into the desired position allows the user to properly position the photographic accessory, and then secured in the position. The connectors can be rotated before or after the accessory is mounted or secured. Screw (not shown) is tightened to prevent connectors from rotating, or loosened to allow the user to rotate the connectors. In the embodiment shown in FIGS. 1 and 2, the connectors are integrated into a base, and parabolic head 2 is mounted to the light socket. In this embodiment, the base and connectors rotate about the parabolic head. In addition to screws, other devices can be used to loosen or secure the integrated connector and include for example clips, fasteners, snaps, ties, clamps and the like.

The integrated light head connector of the present invention is connected to a power source. Power source 6 has bulb socket 8, electrical input 26, multiple heat channels 28A, B, and C, and vents 30. Multiple heat channels and vents, which are included in the present invention, allow for an air exchange between the heated air from the power source, and cooler air surrounding the power source. The rotation of the integrated light head connector can be accomplished, in an embodiment, with a threaded connection or lip mated or adapted to receive the power source. Other adaptations or mechanisms can be used to allow the connectors to rotate.

The present invention includes methods for providing lighting for a photographic shoot using the light head of the present invention. The methods include installing the light head on a light stand or other support, and installing a photographic accessory (e.g., a softbox) on the light head. The methods encompass providing power to the power source (e.g., plugging in the light head), and taking photographs.

Kits and systems, having the light head described herein, are also included by the present invention. Such kits or systems encompass the integrated light head of the present invention, and one or more of the following: a photographic accessory (e.g., softbox), plug, devices for securing the accessory (e.g., wing screws, clips, fasteners, carrying cases, light stands, reflectors, umbrellas, softboxes, barn door, scrims, filters, gels, bulbs, louvers, grids, etc.).

### EXEMPLIFICATION

The integrated light heads shown in FIG. 1 (the 6-connector light-head) and in FIG. 3 (the 8-connector light-head) were made. The power source was obtained from amvona.com (model No.: DP-LH2, Mansfield, Mass.). The base of the parabolic head and integrated connectors were made from dye cast metal. The power source and base were threaded to allow the connectors to rotate both in a clockwise and counterclockwise direction with respect to the power source. The parabolic head was connected to the light socket of the power source, and made from a textured, reflective surface. The reflective surface of the parabolic head is made from aluminum material.

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1. A light head that comprises:
a. a parabolic head;
b. at least one connector at the parabolic head; and
c. a power source for electrically powering the parabolic head.

2. The light head of claim 1, wherein the power source is adapted to receive the parabolic head.

3. The light head of claim 2, wherein the connector rotates clockwise, counterclockwise, or both, with respect to the device for electrically powering the parabolic head.

4. The light head of claim 1, wherein the parabolic head includes a base having at least one the connector, shaped to receive the parabolic head.

5. The light head of claim 3, wherein the power source is threaded to receive the base.

6. The light head of claim 2, wherein the light head further comprises an attachment for slidably attaching the base with the power source.

7. The light head of claim 1, wherein the device further includes a light socket.

8. The light head of claim 7, wherein the parabolic head has a reflective surface.

9. A light head that comprises:
a. a parabolic head;
b. at least about six connectors at the parabolic head; and
c. a power source for electrically powering the parabolic head, wherein the power source is adapted to receive the parabolic head,
wherein the connector rotates clockwise, counterclockwise, or both, with respect to the power source.

10. The light head of claim 9, wherein said connectors comprises at least one connector shaped to receive a softbox frame member.

11. A connector at a parabolic head, the connector comprises a keyhole and is shaped to receive a member of a photographic accessory.

12. The connector of claim 11, wherein the keyhole comprises:
a. a front face, wherein the front face is adapted to receive a frame member of a softbox member, and
b. at least one side face, wherein the side face is adapted to secure the frame member.

13. A lighting system, said system comprises:
a. a parabolic head;
b. at least one connector at the parabolic head;
c. a power source for electrically powering the parabolic head; and
d. a photographic accessory.

14. The lighting system of claim 13, wherein the photographic accessory includes a softbox.

15. A method for providing lighting with the light head of claim 1, wherein the method includes:
a. attaching a photograph accessory to the connector, and
b. providing electricity to the power source.

16. The method of claim 15, wherein the method includes attaching a softbox to the connector.

17. A lighting kit, the kit comprises:
a. a parabolic head;
b. at least one connector at the parabolic head;
c. a power source for electrically powering the parabolic head; and
d. a photographic accessory.

18. The lighting kit of claim 17, wherein the photographic accessory includes a softbox.
